(19) United States
(12) Patent Application Publication
(10) Pub. No.: US 2026/0286848 A1
(43) Pub. Date: Sep. 24, 2026

(54) EXPANDER AND METHOD OF MANUFACTURING

(71) Applicant: Nuovo Pignone Tecnologie - S.r.l., Florence (IT)

(72) Inventors: Gabriele GIREZZI, Florence, Firenze (IT); Giacomo RAGNI, Florence, Firenze (IT); Paolo DI SISTO, Florence, Firenze (IT); Damaso CHECCACCI, Florence, Firenze (IT); Lorenzo COSI, Florence, Firenze (IT); Enrico GIUSTI, Florence, Firenze (IT); Fabio VALERI, Florence, Firenze (IT)

(21) Appl. No.: 19/469,808

(22) PCT Filed: Mar. 25, 2024
(86) PCT No.: PCT/EP2024/025126

§ 371 Date: Sep. 26, 2025

(30) Foreign Application Priority Data
Mar. 31, 2023 (IT) 102023000006342

(51) Int. Cl. F01D 5/06; F01D 5/08; F01D 5/30

(52) U.S. Cl. CPC F01D 5/063; F01D 5/066; F01D 5/085; F01D 5/3038; F05D 2230/233

(57) ABSTRACT

Disclosed herein is an expander for a supercritical carbon dioxide thermodynamic cycle. The expander comprises an outer casing, a combustor in the outer casing, and a rotor with a rotation axis, housed for rotation in the outer casing. The rotor comprises an aft shaft portion, and a forward shaft portion. Between the aft shaft portion and the forward shaft portion a plurality of rotor disks are arranged. Each rotor disk comprises a respective annular row of rotor blades. Upstream of each annular row of rotor blades, a respective annular row of stationary vanes is provided. Each annular row of stationary vanes and the respective annular row of rotor blades form an expander stage.

### TECHNICAL FIELD

The present disclosure concerns gas expanders particularly adapted for use in oxy-fuel power cycles operating with process gas at high pressures, for instance CO₂ cycles, such as Allam cycles, aka NET Power cycles. The present disclosure further concerns methods for assembling rotors for supercritical carbon dioxide expanders.

### BACKGROUND ART

Fossil fuels are a major source of chemical energy used for the generation of mechanical power. Fossil fuels are mixed with air and combusted to generate a combustion gas at high pressure and temperature, which expands in a turbine or an expander. The expander converts combustion gas enthalpy into mechanical power available on the output shaft of the expander and used to drive a load, such as a compressor or compressors train, or to rotate an electric generator and convert mechanical power into electric power.

One of the major concerns regarding combustion of fossil fuels relates to the production of carbon dioxide, a greenhouse gas which is considered one of the main contributors of global warming and climate changes.

To reduce the environmental impact of power generation through combustion of fossil fuels, the option of post combustion capture of carbon dioxide has been investigated. Carbon dioxide capture facilities have been developed, to process flue gas exhausted from gas turbines and remove carbon dioxide therefrom, prior to discharging the flue gas in the environment. The cost of a carbon dioxide capturing facility are high, both in terms CAPEX, as well as in terms of energy required to run the facility, which reduces the overall thermodynamic efficiency of the system since the percent-age of carbon dioxide in flue gas is low. This requires large volumes of flue gas to be processed through the carbon dioxide capturing facility and renders the capturing process particularly inefficient.

In recent years oxy-combustion cycles, also known as oxy-fuel cycles, have been developed, wherein fuel, such as natural gas or another fossil fuel, is blended into a mixture of an oxidant consisting mainly of oxygen (O₂) and carbon dioxide (CO₂) at high pressure. The blend of fuel, oxygen and carbon dioxide burns in a combustor of an expander producing a pressurized flue gas consisting exclusively or almost exclusively of carbon dioxide and water.

The flue gas is expanded in the expander to generate mechanical power. The exhausted flue gas discharged at the discharge side of the expander is cooled in a regenerative heat exchanger and further chilled to condensate water which can thus be removed from the chilled flue gas. The low-temperature flue gas, consisting mainly or exclusively of carbon dioxide is pressurized and recycled through the regenerative heat exchanger towards the combustor of the expander.

Oxygen supplied to the combustor of the expander can be obtained by separation from ambient air, removing nitrogen therefrom, such that the working fluid supplied to the combustor mainly consists of oxygen and carbon dioxide and does not include nitrogen. The resulting flue gas mainly consists of water and carbon dioxide. Water is removed from the flue gas by condensation and the part of water-free flue gas, which is not recycled to the combustor, can be efficiently processed in a carbon dioxide capturing unit.

The oxy-fuel cycle summarized above is a semi-closed cycle, in that only a fraction of the flue gas exits the cycle after water has been removed therefrom.

Oxy-fuel or oxy-combustion cycles, such as those described above, are particularly interesting in terms of efficiency and reduction of noxious emissions. However, they operate under CO2 supercritical conditions at the inlet of the expander and are characterized by a high pressure drop across the expander and a high torque applied to the rotor of the expander. These factors become critical and raise serious challenges in the expander rotor design, when the rated power of the expander increases, and may pose limitations to the maximum power rate of the expander.

A novel expander adapted to achieve higher power rates, for instance in an oxy-fuel cycle or other supercritical carbon dioxide cycle, would be welcomed in the art.

### SUMMARY

Disclosed herein is an expander for a supercritical carbon dioxide thermodynamic cycle. As understood herein, a “supercritical carbon dioxide thermodynamic cycle” is a cycle wherein carbon dioxide is in a supercritical condition at least at the inlet of the expander.

The expander comprises an outer casing, a combustor combined with the outer casing, and a rotor with a rotation axis, housed for rotation in the outer casing. The rotor comprises an aft shaft portion, and a forward shaft portion. Between the aft shaft portion and the forward shaft portion a plurality of rotor disks are arranged. Each rotor disk comprises a respective annular row of rotor blades. Upstream of each annular row of rotor blades, a respective annular row of stationary vanes is provided. Each annular row of stationary vanes and the respective annular row of rotor blades form an expander stage.

The plurality of rotor disks between the aft shaft portion and the forward shaft portion are connected to one another by welding-At least a section of the aft shaft portion is welded to a most aft rotor disk of the plurality of rotor disks, i.e. to the rotor disk adjacent to the aft shaft portion. Finally, at least a portion of the forward shaft portion is welded to a most forward rotor disk of the plurality of rotor disks, i.e. to the rotor disk adjacent to the forward shaft portion.

The resulting rotor is thus formed by a plurality of components, each of which can be manufactured separately and can be made of a temperature-resistant metal alloy. Since the individual components are small compared with the entire rotor, manufacturing with high-temperature metal alloys, such as a nickel-based alloy, is simple. Welding of the individual components results in a rotor of large dimension, which may include a large number of annular rows of rotor blades, corresponding to a large number of expansion stages. Welding results in a strong structure adapted to resist high pressures and high torques, which typically develop in a supercritical carbon dioxide expander.

The suggested design can be used to achieve high power rates, preferably higher than 50 MW, for instance in the order of 100 MW or higher, for instance of 150 MW or higher, e.g., 200 MW or higher, or 300 MW or higher. In embodiments, the rated power can be lower than 2000 MW, preferably lower than 1500 MW, for instance lower than 1000, or lower than 800 MW. For instance, the rated power can be comprised between 200 MW and 650 MW. Intermediate values of the upper and lower limit of each range mentioned above are also expressly disclosed herein.

Further features and embodiments are described below and outlined in the attached claims.

The present disclosure also concerns a method of manufacturing a rotor for a supercritical carbon dioxide expander and a thermodynamic cycle using said expander.

### BRIEF DESCRIPTION OF THE DRAWINGS

Reference is now made briefly to the accompanying drawings, in which:

FIG. 1 is a schematic of an oxy-fuel power circuit;

FIG. 2 is a sectional view along of an expander according to the present disclosure in a first embodiment;

FIG. 3 is a sectional view of a rotor for the expander of FIG. 2 in a further embodiment, wherefrom the rotary blades have been removed;

FIG. 4 is an enlargement of a welding area after machining for removal of annular rabbet.

### DETAILED DESCRIPTION

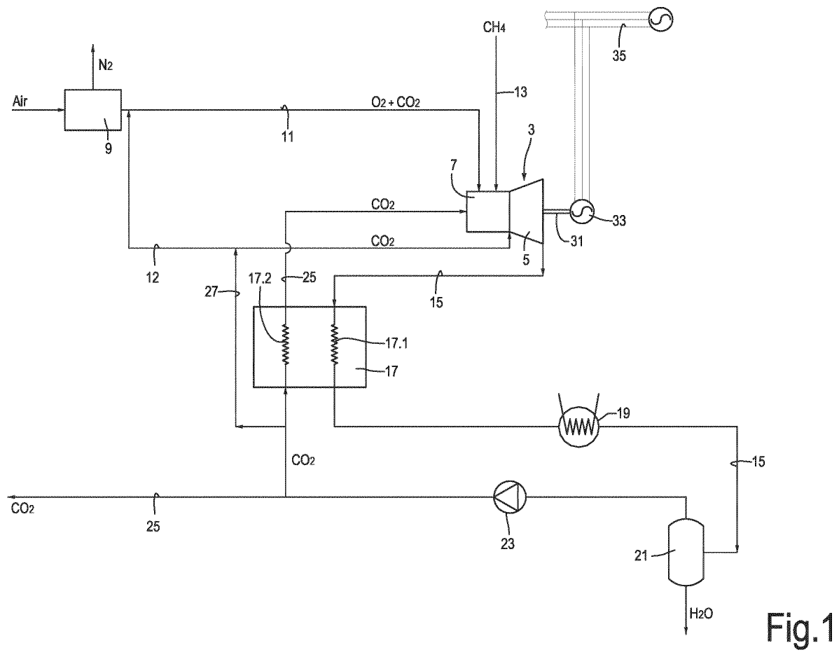

The schematic of FIG. 1 illustrates a simplified supercritical carbon dioxide cycle (shortly sCO₂ cycle), such as an Allam cycle or as similar oxy-fuel combustion cycle, in which the use of an expander according to the present disclosure can be particularly beneficial. In general terms, a supercritical carbon dioxide cycle as understood herein is a cycle wherein carbon dioxide is in a supercritical condition at least at the inlet of the expansion flow path in the expander.

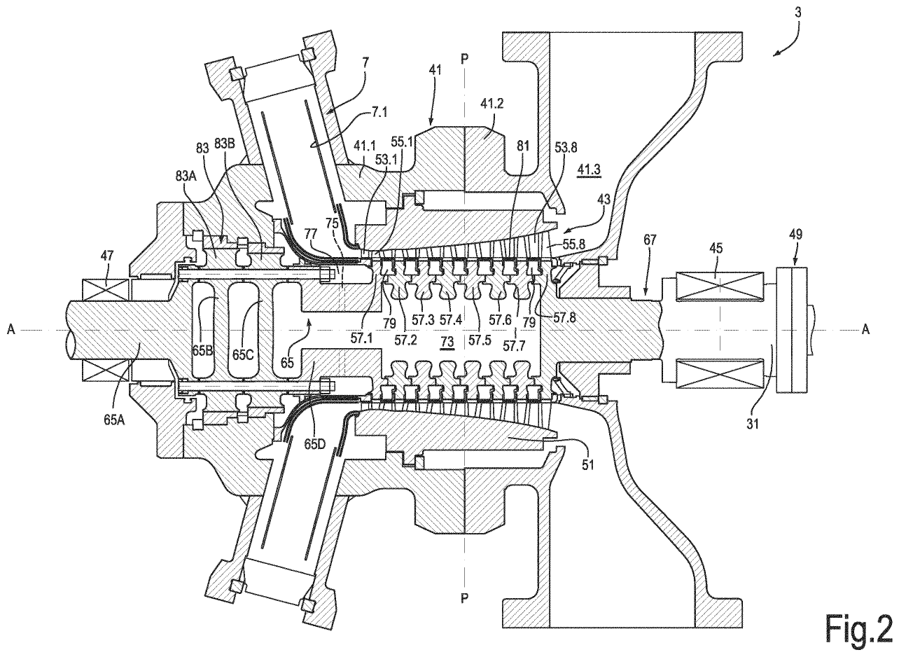

The power system 1 shown in FIG. 1 comprises an expander (aka turboexpander) 3 that includes an expansion section 5 and a combustor 7. The combustor 7 can be an annular combustor, a can-type combustor, a can annular combustor, or the like, for instance. In currently preferred embodiments, the combustor is a can-type combustor comprising a plurality of combustion chambers arranged around the rotation axis of the expander 3, as shown in more detail in FIG. 2. In some embodiments, as schematically shown in FIG. 2, the combustion chambers are housed in a high-pressure casing of the expander, as will described in more detail below. In some embodiments, each combustion chamber is housed in a respective seat formed in a high-pressure casing of the expander, as will be described in more detail below.

Reference number 7.1 in FIG. 2 designates single combustor chambers of a can-type or can annular combustor. In other embodiments, not shown, the combustor can be an annular combustor, as mentioned.

The combustor 7 is supplied with an oxidant flow delivered by an oxidant source. The oxidant may be oxygen (O₂) or a blend comprising, or mainly consisting of oxygen and carbon dioxide (CO₂). The oxidant flow can be produced by an air separation unit 9, which features an oxidant source. The air separation unit 9 may remove nitrogen or nitrogen and carbon dioxide from ambient air to produce the required oxidant stream which is supplied through an oxidant line 11 to the combustor 7 of the expander 3. In some embodiments, for the sake of easier handling of the oxidant flow, the latter may include around 20% in volume of oxygen and 80% in volume of carbon dioxide. The CO₂ and O₂ percentages mentioned above are by way of example. The carbon dioxide can be added to the oxygen through a recycling line 12, as explained in more detail below.

Reference number 13 indicates a fuel supply line, for instance adapted to supply natural gas, such as methane to the combustor 7, specifically to each combustion chamber 7.1. The oxidant and the fuel are supplied at the inlet side of the expander 3 to the combustor 7 at high pressure. The upper pressure of the thermodynamic cycle can be, for instance, 50 barA or above, preferably 100 barA or above, for instance around or above 200 barA, preferably around or above 250 barA, or higher, for instance equal to or higher than 300 barA. In general, the pressure can be lower than 800 barA, or lower than 600 barA. In some embodiments, the upper pressure of the thermodynamic cycle, i.e. the pressure in the combustor and at the first expansion stage can be 100, 150, 200, 250, 300, or 350 barA.

The oxidant-fuel blend is burned in the combustor 7. Pressurized, hot combustion gas resulting from the combustion expands in the expansion section 5 of the expander 3. The temperature at the exit side of the stationary nozzles downstream the combustor can be comprised between 800° C. and 1500° C., for instance.

The exhausted flue gas is discharged after expansion at a discharge side of the expander 3 in a discharge line 15. The flue gas in the discharge line 15 can be at a temperature between about 400° C. and about 700° C., for example around 600° C., and at a pressure which may range between about 10 barA and about 100 barA, preferably between about 20 barA and about 60 barA.

The circuit further comprises a regenerative heat exchanger 17, wherein hot flue gas flowing through a hot side 17.1 of the regenerative heat exchanger 17 is cooled in heat exchange with a flow of chilled flue gas which flows through a cold side 17.2 of the regenerative heat exchanger 17. The flue gas discharged from the hot side 17.1 of the regenerative heat exchanger 17 is further chilled in a chilling heat exchanger 19 to a temperature which causes condensation of steam contained in the exhausted flue gas. Condensing water is removed from the exhausted flue gas in a water/gas separator 21.

The de-hydrated exhausted and chilled flue gas, consisting mainly or exclusively of carbon dioxide, is compressed in a flue gas compressor 23 to the pressure at the inlet side of the expander 3. While in the schematic of FIG. 1 the flue gas compressor 23 is pictorially represented as a single compressor, in some embodiments a multiple compressor can be used. For instance, the flue gas compressor 23 can be a multi-stage compressor or a compressor train. In some embodiments, the compressor can be an intercooled compressor. In some embodiments, a main compressor can be set in series with two sequentially arranged pumps.

The compressed flue gas delivered by the flue gas compressor 23 is partly removed from the cycle through a discharge line 25. If the compressor 23 is featured by a plurality of compressing turbomachines arranged in series, the discharge line 25 can be connected between two sequentially arranged turbomachines and/or at the discharge side of the most downstream compressing turbomachine.

The remaining compressed flue gas is delivered through the cold side 17.2 of the regenerative heat exchanger 17 and is heated by heat exchange with the hot flue gas flowing through the hot side 17.1 of the regenerative heat exchanger 17, and recycled to the expander 3 through a recycle line 25. The flue gas recycled through recycle line 25 is mixed with the combustion gas generated in the combustor 7, or with the oxidant stream from oxidant line 11.

A side stream of chilled flue gas is delivered through a cooling line 27, which bypasses the regenerative heat exchanger 17, towards components of the expander 3 which require cooling.

The expander 3 may include an output shaft end 31 which can be integral with the central portion of the rotor, or can be assembled with the central portion of the rotor by bolting, welding, Hirth or spline connections, or the like, or a combination thereof. The mechanical power generated by the expansion of the combustion gas in the expansion section 5 of the expander 3 is available on the output shaft end 31 for mechanical drive or power generation purposes. In the exemplary embodiment of FIG. 1 the output shaft end 31 is drivingly coupled to an electric generator 33 directly or through a gearbox, a joint or combinations thereof. A flanged connection between the outputs shaft end 31 and the electric generator 33 is shown at 49 in FIG. 2. The electric generator 33 is in turn electrically coupled to an electric power distribution grid 35. In FIGS. 1 and 2 the output shaft end 31 is shown at the aft side of the expander 3. In other embodiments, not shown, the output shaft end 31 can be arranged at the forward side of the expander. In yet further embodiments, not shown, two output shafts ends can be provided, one at the forward side and one at the aft side of the expander.

As used herein “forward” and “aft” are referred to the direction of flow of the process gas through the expander 3. Therefore, “forward” indicates a position on the side of the combustor 7 and “aft” indicates a position on the side opposite the combustor 7, i.e., the discharge side of the expander 3.

The high pressure drop across the expander 3, the high absolute pressure in the combustor 7 and in the cooling ducts of the expanders, as well as the high torque applied to the expander shaft pose serious challenges in the design of the expander 3, in particular for high rated powers, for instance at or around 100 MW or above, such as between 100 MW and 2000 MW, preferably at or above 150 MW and below 2000 MW. The expander, and specifically the rotor design disclosed herein, can be used to achieve high power rates, preferably higher than 50 MW, for instance in the order of 100MW or higher, for instance of 150 MW or higher, e.g. 200 MW or higher, or 300MW or higher. In embodiments, the rated power can be lower than 2000MW, preferably lower than 1500 MW, for instance lower than 1000 MW, or lower than 800 MW. For instance, the rated power can be comprised between 200 MW and 650 M. Intermediate values of the upper and lower limit of each range mentioned above are also expressly disclosed herein.

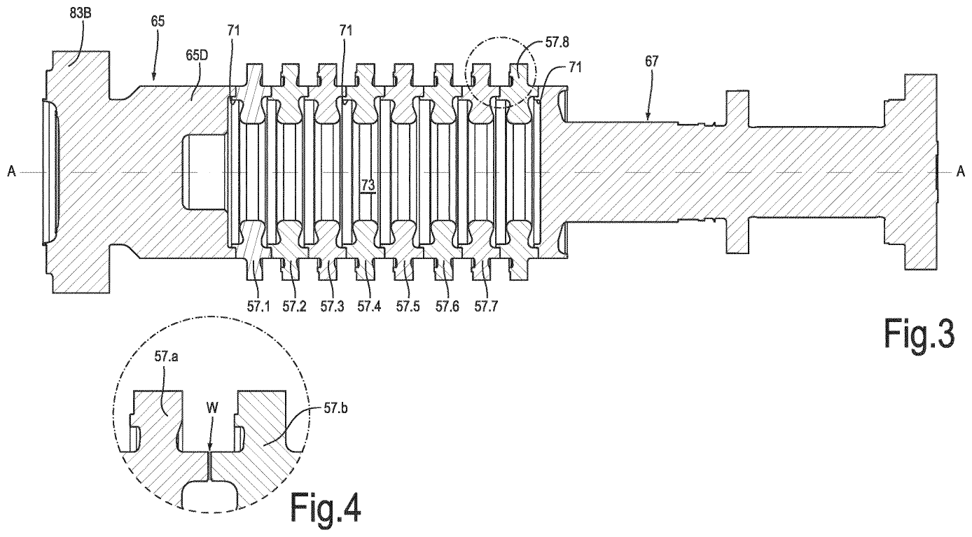

With continuing reference to FIG. 1, FIG. 2 illustrates a sectional view of the expander 3 in one embodiment. By way of example, the expander of FIG. 2 includes a rotor in one embodiment. A further embodiment of an alternative rotor for the expander 3 of FIG. 2 is shown in isolation in FIG. 3 which is shown in isolation in FIG. 3.

In some embodiments, the expander 3 comprises an outer casing 41, which houses the combustor 7. In some embodiments the outer casing 41 includes a main body 41.1, referred to herein as a high-pressure casing, and a closure 41.2, referred to herein as a low-pressure exhaust casing. The high-pressure casing 41.1 can include a main body which can be monolithic, i.e., can consist of a single piece, for instance manufactured by forging, machining, casting, or combinations thereof. In some embodiments, the high-pressure casing 41.1 can be manufactured by welding to one another a plurality of components, preferably interfaced along a plane orthogonal to the rotation axis.

The low-pressure exhaust casing 41.2 can be positioned at the discharge side, i.e. the aft side, of the expander 3, i.e., on the side opposite the combustor 7. The low-pressure exhaust casing 41.2 can be monolithic, i.e. can consist of a single piece, for instance manufactured by forging, machining, casting, or combinations thereof. In some embodiments, the low-pressure exhaust casing 41.2 can be manufactured in two or more components which can be connected irreversibly to one another, e.g., by welding, or which can be coupled to one another in a reversible manner, e.g., by means of bolts or the like. For instance, the low-pressure exhaust casing 41.2 can be split into two portions along a plane containing the rotation axis of the expander.

The high-pressure casing 41.1 and the low-pressure exhaust casing 41.2 can be connected to one another along a plane P which is orthogonal to a rotation axis A-A of a rotor 43 supported for rotation in the outer casing 41.

In some embodiments, the low-pressure exhaust casing 41.2 forms a discharge volute or a discharge plenum 41.3, through which exhausted flue gas is discharged from the expander 3.

Reference numbers 45, 47 indicate bearing arrangements, which rotatingly support the rotor 43. For instance, the bearing arrangement 45 on the side opposite the combustor 7, i.e. on the aft side, may include an axial or thrust bearing in combination with a radial bearing, or a bearing having an axial-radial bearing capability. The bearing arrangement 47 on the combustor side, i.e. on the forward side, may include a radial bearing. A reversed arrangement is also possible, with a bearing having axial load capability arranged on the combustor side. The bearing arrangements 45, 47 can be arranged in bearing casings, not shown in detail.

In some embodiments, the rotor 43 is surrounded by one or more inner casings 51, stationarily housed in the outer casing 41. Each inner casing 51 can be split into two portions along a plane parallel to the rotation axis A-A of the rotor 43, for instance a plane containing the rotation axis A-A. The arrangement of inner casings 51 and outer casing 41 is particularly beneficial when the combustion gas reaches high pressures, around 200-300 barA or higher. The monolithic high-pressure casing 41.1 can withstand the loads generated by the high pressure inside the outer casing, while the inner casings 51 facilitate mounting of the stationary vanes or stationary blades, described below.

The pressure drop across the expander 3 can be around 150 bar or higher, preferably around 200 bar or higher, for instance between 250 and 400 bar. To expand the combustion gas generated in the combustor 7 a high number of expansion stages is preferred. In the exemplary embodiment of FIGS. 2 and 3, the expander 3 includes eight stages. In other embodiments, a different number of expansion stages can be foreseen, preferably equal to or higher than four, more preferably equal to or higher than five. In some embodiments, the number of expansion stages can be higher than eight, for instance nine, ten, eleven or more, and preferably lower than fifteen. The expansion stages form an axial expansion flow path for the process gas being expanded in the expander 3.

Each expansion stage includes an annular row of stationary vanes or stationary blades 53 that are stationarily arranged in the outer casing. In the exemplary embodiment of FIG. 2, the annular rows of stationary blades are housed in the inner casings 51. Each expansion stage further includes a respective annular row of rotor blades 55, arranged downstream the respective annular row of stationary blades 53 along the expansion flow path which extends from the combustor to the discharge plenum 41.3 in a forward-to-aft direction, through the expansion section 5.

In some embodiments, a first annular row of stationary blades 53.1 can be arranged at the discharge end of the combustor 7 and form an array of nozzles directing hot, high-pressure gas from the combustion chambers of the combustor to the first row of rotor blades. A first annular row of rotor blades labeled 55.1 can be arranged directly downstream of the first annular row of stationary blades 53.1 adjacent the combustor 7. A last annular row of stationary blades 53.8 can be positioned near the discharge plenum 41.3, upstream of the last annular row of rotor blades shown at 55.8. Reference number 55 generically refers to any one of the annular rows of rotor blades or to a rotor blade as such.

The rotor blades 55 form part of the rotor 43, i.e., are connected thereto for co-rotation with the rotor shaft. In embodiments, each annular row of rotor blades 55 (i.e., each row 55.i, with i=1 to 8) is connected to a respective rotor disk. The rotor disks are labeled 57.i, with i=1 to 8. Reference number 57 indicates a generic rotor disk.

The rotor 43 further includes a forward shaft portion 65 and an aft shaft portion 67. Each shaft portion 65, 67 can in turn comprise a single monolithic structure, i.e., can be formed of a single body, or can comprise a plurality of sections which can be connected to one another by tie rods or the like. In FIG. 2 the aft shaft portion 67 is monolithic, while the forward shaft portion 65 comprises four sections 65A, 65B, 65C and 65D, which are mutually stacked and connected to one another by tie rods 66.

In the embodiment of FIG. 2 the first rotor disk 57.1 is formed monolithically as a single piece or body with forward shaft portion 65, and more specifically with the section 65D thereof. Similarly, the last rotor disk 55.8 is formed monolithically as a single piece with the aft shaft portion 67. Intermediate rotor disks 57.2, 57.3, 57.4, 57.5, 57.6 and 57.7 form a plurality of rotor disks which are manufactured as separate components and assembled between the forward rotor disk 57.1 and aft rotor disk 57.8 by welding, as described in more detail below. The most aft one of the plurality of rotor disks, i.e. the rotor disk 57.7, is welded to the aft shaft portion and the most forward one of the plurality of rotor disks, i.e., the rotor disk 57.2, is welded to the forward shaft portion 65.

In the embodiment of FIG. 3, the rotor comprises again eight rotor disks 57.1 to 57.8, which however are manufactured all as separate bodies, such as by forging or other suitable means, and connected to one another and to the forward shaft portion 65 and aft shaft portion 67 by welding. In FIG. 3 the rotor blades are omitted for clarity. In this embodiment the most forward rotor disk 57.1 is welded to the forward shaft portion 65 and the most aft rotor disk 57.8 is welded to the aft shaft portion 67.

The rotor blades of each stage can be manufactured separately from the respective rotor disk and mechanically mounted thereon. In other embodiments, the rotor blades and the rotor disk of each stage can be manufactured as a monolithic body, for instance by additive manufacturing. In yet further embodiments, the two design options can be combined. One or some stages may include respective monolithically manufactured components including rotor blades and disks, and one or some stages may include a rotor disk and separately manufactured rotor blades mechanically coupled to the rotor disk.

As mentioned above, the forward shaft portion 65, and the section 65D thereof, the rotor disks 57 and the aft shaft portion 67 are connected to one another by welding. In some embodiments, welding is an autogenous welding, and specifically a welding without the use of additional filler material. Welding is achieved by melting a portion of the base material forming the two components to be connected to one another by supplying energy thereto, and subsequently solidifying the melted base material.

In some embodiments, welding is an electron beam welding. This welding technique is an autogenous welding process in which a beam of high-velocity electrons is applied to two materials to be joined. The workpieces melt and flow together as the kinetic energy of the electrons is transformed into heat upon impact. Electron beam welding can be beneficial for welding to one another the rotor disks and the forward shaft portion 65 and aft shaft portion 67, since the molten volume can be narrow in the axial direction and thick in the radial direction. For instance, the volume of melted material may have an extension in axial direction around or above 0.1 mm, preferably at around or above 2 mm, or higher, for instance around or above 10 mm, and preferably smaller than 15 mm. The volume of melted material may have a thickness in the radial direction for instance around or above 10 mm, preferably at around or above 60 mm, or higher, for instance at or above 200 mm. This results in strong welding thanks to the extension in the radial direction, but reduced thermal distortions of the welded workpieces, thanks to the limited dimension of the weld in the axial direction. Additionally, thermally-caused alterations of the physical and chemical properties of the base material forming the various components of the rotor 43 are reduced.

In some embodiments, the welding process for manufacturing the rotor 43 can start from the forward shaft portion 65. In the embodiment of FIG. 2 the second rotor disk 57.2 is stacked on top of the first rotor disk 57.1 which is manufactured as a part of the single body which also forms the section 65D of the forward shaft portion 65.

The rotor disk 57.2 is welded to the rotor disk 57.1. The next step will be welding of the third rotor disk 57.3 to the second rotor disk 57.2. The welding steps are repeated until the second last rotor disk 57.7 is welded to the rotor disk 57.6. The assembling process is completed by welding the aft shaft portion 67 and the last rotor disk 57.8 formed monolithically therewith, to the second last rotor disk 57.7.

In the embodiment of FIG. 3, a similar sequence of manufacturing steps is performed, with the difference that each one of the eight rotor disks 57.1-57.8 is manufactured as separate component and the disks are then welded one after the other starting from rotor disk 57.1 welded to section 65D of the forward shaft portion 67.

In other embodiments the welding process can be reversed, starting by welding the rotor disk 57.8 to the aft shaft portion 67 (in FIG. 3) or the rotor disk 57.7 to the aft shaft portion 67 integrally formed with the rotor disk 57.8 (in FIG. 2), followed by sequential welding of the other rotor disks from 57.7 (FIG. 3), or 57.6 (FIG. 2) till rotor disk 57.1 (FIG. 3) or 57.2 (FIG. 2) and finally welding the forward shaft portion 65, i.e. the section 65D thereof.

In some embodiments, to facilitate the mutual positioning of the rotor disks 57 and of the forward shaft portion 65 and aft shaft portion 67, the rotor disks 57 and the last shaft portion to be welded (in the embodiment shown in FIG. 3 the aft shaft portion 67) can be provided with inner annular rabbets 71. Each inner annular rabbet 71 is used to center the respective component (57 or 67) to the adjacent one before welding. Thus, for instance, in the embodiment of FIG. 3 the inner annular rabbet 71 of the first rotor disk 57.1 is introduced into a circular seat of the forward shaft portion 65 to center the first rotor disk 57.1 with respect to the forward shaft portion 65. After welding of the first rotor disk 57.1 to the forward shaft portion 65, and more specifically to the section 65D thereof, the next rotor disk 57.2 is mounted on the first rotor disk 57.1 and centered therewith using the respective inner annular rabbet that is introduced into a hole of the first rotor disk 57.1, such that the first rotor disk 57.1 surrounds the inner annular rabbet 71 of the next rotor disk 57.2. Welding of the rotor disk 57.2 to the rotor disk 57.1 is then performed. The process is repeated until the aft shaft portion 67 is centered with respect to the last rotor disk 57.8 using the inner annular rabbet 71 of the aft shaft portion that is introduced into the central hole of rotor disk 57.8. The last welding is then performed.

In some embodiments, at least one or all except one annular rabbet 71 are removed after welding. FIG. 4 illustrates an enlargement of a pair of rotor disks, generically labeled 57.a and 57.b. The inner annular rabbet 71 of the rotor disk 57.b has been removed by machining to generate as smooth transition zone between the rotor disk 57.a and the rotor disk 57.b in the inwardly facing surface thereof, in the area of the welding. The volume of the molten and solidified base material forming the welding connection is schematically shown at W. The removal of the inner annular rabbet 71 reduces the risk of failure due to crack initiation.

Since the last component to be welded (e.g. the aft shaft portion 67) closes the empty volume inside the rotor, one annular rabbet 71, for instance the rabbet of the aft shaft portion, will not be accessible for machining and will not be removed after welding.

The volume of metallic material forming the welded seam between the ad-joining rotor disks 57a, 57b has a dimension Wa in the axial direction and a dimension Wr in the radial direction. Preferably, the dimension Wa is comprised between 0.1 and 15 mm, or between 0.1 and 10 mm. The dimension Wr is comprised between preferably between 10 and 200 mm. A small dimension in the axial direction is beneficial in terms of dimensional stability of the rotor. Welding can be preferably an electron beam welding, which is particularly useful in generating deep welding (large radial dimension Wr) with reduced extension in the axial direction (small axial dimension Wa).

After welding of the rotor disks 57 and of the forward aft portion 65 and aft shaft portion 67 a cooling chamber 73 is obtained in the rotor. The cooling chamber 73 can be fluidly coupled through one or more ducts 75 (FIG. 2) with a cooling plenum 77 adapted to receive a cooling fluid, for instance chilled flue gas, mainly consisting of carbon dioxide, from cooling line 27. The cooling chamber 73 can be fluidly coupled with annular spaces 79 provided between adjacent rotor disks 57 and between the first and last rotor disk and the forward and aft shaft portion, respectively. Each annular space 79 can be radially outwardly closed by an annular seal or a seal runner 81. Pressurized cooling fluid from the cooling chamber 73 thus flows into each annular space 79 at a pressure sufficient to purge the annular space. Decreasing pressure of the cooling fluid in the annular spaces 79 can be obtained by using connection ducts of decreasing cross section, such that the correct flowrate of cooling fluid is obtained in the several annular spaces 79.

In some embodiments, the rotor 43 of the expander 3 can include a balance drum, adapted to balance the axial force generated by the expanding process gas flowing through the flow path. The balance drum can be provided on the aft shaft portion 67, on the forward shaft portion 65, or on both the aft shaft portion 67 and the forward shaft portion 65.

In the embodiments of FIGS. 2 and 3, a balance drum 83 is provided on the forward shaft portion 65, as best shown in FIG. 2 In some embodiments, the balance drum 83 comprises two drum portions 83A and 83B. The two drum portions 83A and 83B can be monolithically formed as a single body with a respective one of the several sections forming the respective forward shaft portion 65 or aft shaft portion 67. In FIG. 2 the balance drum 83 is includes two drum portions 83A, 83B integrally formed with the sections 65B and 65C of the forward shaft portion. Splitting the balance drum into individual drum portions makes manufacturing thereof easier.

Exemplary embodiments have been disclosed above and illustrated in the ac-companying drawings. It will be understood by those skilled in the art that various changes, omissions and additions may be made to that which is specifically disclosed herein without departing from the scope of the invention as defined in the following claims.

1-22. (canceled)

23. An expander for a supercritical or transcritical carbon dioxide thermodynamic cycle, the expander comprising:
an outer casing;
a combustor in the outer casing, the combustor being adapted to receive a flow of compressed oxidant and a fuel;
a rotor with a rotation axis, housed for rotation in the outer casing; wherein the rotor comprises:
an aft shaft portion;
a forward shaft portion; and
a plurality of rotor disks arranged between the aft shaft portion and the forward shaft portion; wherein each rotor disk of said plurality of rotor disks comprises a respective annular row of rotor blades; and
upstream of each annular row of rotor blades, a respective annular row of stationary vanes; wherein each annular row of stationary vanes and the respective annular row of rotor blades form an expander stage;
a cooling chamber inside the rotor; wherein the cooling chamber is fluidly coupled to a high-pressure plenum adapted to receive compressed cooling fluid; and wherein the cooling chamber is fluidly coupled to at least some of said expander stages
wherein: the plurality of rotor disks between the aft shaft portion and the forward shaft portion are connected to one another by welding; at least a section of the aft shaft portion is welded to a most aft rotor disk of the plurality of rotor disks; and at least a portion of the forward shaft portion is welded to a most forward rotor disk of the plurality of rotor disks.

24. The expander of claim 23, wherein the rotor disks, the aft shaft portion and the forward shaft portion are welded to one another by electron beam welding.

25. The expander of claim 23, wherein between adjacent rotor disks, between the forward shaft portion and a rotor disk connected thereto, and between the aft shaft portion and a rotor disk connected thereto a welding volume is provided, having an extension in a direction parallel to the rotation axis of the rotor comprised between 0.1 and 15 mm, preferably between 0.1 and 10 mm, and a radial thickness in a direction orthogonal to the rotation axis of the rotor between 10 and 200 mm.

26. The expander of claim 23, wherein the cooling chamber is circumferentially surrounded by the rotor disks and closed at an aft axial end by the aft shaft portion and at a forward axial end by the forward shaft portion.

27. The expander of claim 23, wherein the cooling chamber is fluidly coupled through cooling ducts with annular spaces between pairs of sequentially arranged rotor disks.

28. The expander of claim 27, wherein annular seals or seal runners are arranged between said sequentially arranged rotor disks, the cooling ducts being adapted to supply pressurized cooling fluid from the cooling chamber to an annular space formed between the annular seal or seal runner and the respective two sequentially arranged rotor disks.

29. The expander of claim 23, wherein the rotor further comprises a balance drum.

30. The expander of claim 29, wherein the balance drum is integrally formed with at least one section of the aft shaft portion or the forward shaft portion.

31. The expander of claim 23, wherein the outer casing comprises a high-pressure casing and a low-pressure exhaust casing, wherein the high-pressure casing and the low-pressure exhaust casing are coupled along a plane orthogonal to the rotation axis of the rotor.

32. The expander of claim 31, wherein the low-pressure exhaust casing is arranged at an aft end of the expander, opposite the combustor; and wherein the low-pressure exhaust casing forms a discharge plenum.

33. The expander of claim 31, further comprising at least one inner casing, stationarily housed in the outer casing and surrounding the rotor disks; wherein the at least one inner casing is divided into a first casing portion and a second casing portion along a plane parallel to, or containing the rotation axis of the rotor; and wherein the annular rows of stationary vanes are supported in the inner casing.

34. The expander of claim 23, wherein at least one of said rotor disks comprises an inner annular rabbet, surrounded by an adjacent rotor disk.

35. The expander of claim 23, wherein the rotor is adapted to receive process gas at a temperature comprised between 800° C. and 1500° C.

36. The expander of claim 23, wherein the rotor is adapted to receive process gas at a pressure higher than 50 barA, preferably higher than 100 barA, more preferably equal to or higher than 200 barA, and preferably lower than 800 barA, more preferably lower than 650 barA.

37. The expander of claim 23, adapted to generate a power higher than 50 MW, preferably equal to or higher than 100 MW, preferably lower than 2000 MW, more preferably lower than 1500 MW.

38. The expander of claim 23, wherein at least one of said forward shaft portion and aft shaft portion comprises two shaft sections connected to one another by tie rods.

39. A supercritical carbon dioxide thermodynamic circuit comprising:
an oxidant source;
an expander with an inlet side and a discharge side, wherein the inlet side is fluidly coupled to the oxidant source;
a flue gas recycling line, adapted to recycle flue gas from the discharge side of the expander to a combustor of the expander;
in the flue gas recycling line, a cooler adapted to cool the flue gas from the discharge side of the expander and condense water contained in the flue gas;
a regenerative heat exchanger, wherein flue gas from the expander flows in heat exchange with chilled flue gas from the cooler;
wherein the expander is an expander according to claim 1.

40. A method of manufacturing a rotor for an expander, the rotor having a rotation axis and comprising:
a plurality of rotor disks, each rotor disk comprising a respective annular row of rotor blades;
a forward shaft portion; and
an aft shaft portion; wherein the forward shaft portion, the aft shaft portion and the rotor disks are aligned along the rotation axis of the rotor, the rotor disks being arranged between the forward shaft portion and the aft shaft portion;
wherein the method comprises the step of connecting the forward shaft portion, the rotor disks, and the aft shaft portion by welding; wherein at least one of said rotor disks has an inner annular rabbet adapted to be coupled to an adjacent rotor disk, such that the adjacent rotor disk surrounds the inner annular rabbet, said at least one rotor disk and said adjacent rotor disk being connected by welding; and wherein the method further comprises the step of removing the inner annular rabbet after welding said at least one rotor disk and said adjacent rotor disk to one another.

41. The method of claim 40, wherein the forward shaft portion, the rotor disks, and the aft shaft portion are connected by electron beam welding.

42. The method of claim 40, wherein between adjacent rotor disks, between the forward shaft portion and a rotor disk connected thereto, and between the aft shaft portion and a rotor disk connected thereto a welding volume is provided, having an extension in a direction parallel to the rotation axis of the rotor comprised between 0.1 and 10 mm and a radial thickness in a direction orthogonal to the rotation axis of the rotor between 10 and 200 mm.
